(19) United States
(12) Patent Application Publication
(10) Pub. No.: US 2006/0222473 A1
(43) Pub. Date: Oct. 5, 2006

(54) Self-attaching nut and sealed nut and panel assembly

(76) Inventor: Harold A. Ladouceur, Livonia, MI (US)

Correspondence Address: Raymond E. Scott;HOWARD & HOWARD ATTORNEYS, P.C., The Pinehurst Office Center, Suite #101, 39400 Woodward Avenue, Bloomfield Hills, MI, 48304-5151, US

(21) Appl. No.: 11/098,347

(22) Filed: Apr. 4, 2005

(51) Int. Cl. F16B 37/04

(52) U.S. Cl. 411/180

(57) ABSTRACT

A self-attaching nut for attachment to a panel in sealed relation, which may be formed by rolling, including a generally rectangular central pilot, a flange surrounding the pilot having a first pair of parallel re-entrant grooves on opposed sides of the pilot extending across the length of the nut and a second pair of parallel grooves on opposed ends of the pilot intersecting the first pair of parallel grooves, but not extending across the width of the nut. The flange includes co-planar bearing faces surrounding the pilot.

### FIELD OF THE INVENTION

This invention relates to self-attaching nuts which may be formed in a continuous rolling process and a nut and panel assembly having improved sealing characteristics.

### BACKGROUND OF THE INVENTION

Self-attaching pierce and clinch nuts formed by rolling were first developed by the predecessor in interest of the assignee of this application (Multifastener Corporation) about 50 years ago. Such self-attaching nuts are formed by a continuous rolling process, starting with a round wire which is continuously rolled into the desired cross-section of the self-attaching nut. The cross-section of the nut typically includes a central projecting rectangular pilot portion and flange portions on opposed sides of the nut each including a planar panel bearing face extending parallel to the top face of the pilot portion and spaced below the plane of the top face of the pilot portion. The continuous nut strip is then pierced, forming a nut bore, and the strip is then cut to length, such that the end faces of the self-attaching nut are perpendicular to the top face of the pilot portion and the bearing faces of the flange portions. The nut bore may then be threaded to receive an externally threaded male fastener, such as a screw or bolt, or the bore may remain unthreaded to receive a thread forming or thread rolling male fastener.

In the first embodiment a self-attaching nut developed by the predecessor in interest of the assignee of this application shown in U.S. Pat. Nos. 2,707,322 and 3,845,860, grooves are continuously rolled into the side faces of the pilot portion of the nut strip for clinching the nut to a metal panel as described above. This embodiment of a self-attaching nut has been and continues to be commercially successful and available from the Applicant as the Universal Pierce® nut. A further improvement in self-attaching nuts was made by the predecessor in interest of the Applicant of this application by rolling a “re-entrant” groove in the bearing faces of the flange portions adjacent the pilot portion having relatively inclined inner and outer side walls, wherein the inner wall, which is the outer wall of the pilot portion, is inclined toward the bearing faces of the flange portions and the outer wall is inclined inwardly from the bottom wall toward the pilot portion, forming parallel grooves having a restricted opening adjacent the bearing faces of the flange portions. That is, the width of the parallel grooves adjacent the bearing faces of the flange portions is less than the width of the grooves at the bottom wall. As the panel is driven into the re-entrant grooves by parallel piercing lips of a die member or die button, the panel is deformed beneath the inclined inner and outer side walls of the groove, significantly improving the pull-off strength of the nut and panel assembly. The push-off strength is the force required to push the nut off of the panel following installation in the direction opposite to the direction the nut is installed in the panel. This self-attaching nut was and continues to be very commercially successful and is available from the Applicant as the Hi-Stress® nut and replaced many applications for the Universal Pierce® nut. FIGS. 3 and 4 of U.S. Pat. No. 3,648,747, assigned to the predecessor in interest of the assignee of this application, illustrate a cross-section of the Hi-Stress® nut and FIGS. 5 and 6 of U.S. Pat. No. 3,469,613, also assigned to the predecessor of the assignee of this application, illustrate an earlier embodiment of the method of installation of the Hi-Stress® nut. However, as described further hereinbelow, the commercial embodiments of the Hi-Stress® nut did not include transverse parallel grooves as disclosed in these patents.

As described in the above-referenced patents, the self-attaching nuts are installed in a metal panel in a press, wherein the press typically includes a die member or die button in the lower die platen and the pierce nut is driven by a plunger of an installation head in the upper die platen, piercing a rectangular slug from the panel and the nut is permanently affixed to the panel by a die button which includes parallel piercing lips which, in combination with the outer edges of the pilot portion, pierce the panel and deform the panel portion surrounding the pierced opening into the grooves either in the parallel side faces of the pilot portion in the case of a Universal Pierce® nut or into the grooves in the bearing faces of the nut in the case of a Hi-Stress® pierce nut. The panel may be simultaneously formed during attachment of one or a plurality of pierce nuts in a die press. Alternatively, an opening configured to receive the pilot portion may be preformed in the panel and the nut is clinched to the panel in the press as described above. As used herein, the term “self-attaching nut,” includes both pierce and clinch nuts.

As stated above, the commercial embodiments of the Hi-Stress® self-attaching nuts disclosed in the above-referenced U.S. Pat. Nos. 3,469,613 and 3,648,747 having parallel rectangular grooves in the bearing face of the flange portion extending perpendicular to the re-entrant grooves was not commercially successful. In U.S. Pat. No. 3,469,613, the transverse grooves 60 intersect the re-entrant grooves 50 and extend through the side faces of the nut as shown in FIG. 1. In U.S. Pat. No. 3,648,747, the rectangular grooves 50 shown in FIGS. 5 and 6 intersect the re-entrant grooves 42 shown in FIGS. 3 and 4, but do not extend to the side and end faces of the nut as shown in FIG. 1a. Neither embodiment was commercially successful because the transverse rectangular grooves did not materially improve the push-off strength of the nut and panel assembly, the disclosed transverse rectangular grooves were difficult to roll in a continuous rolling process and thus added costs without a material benefit. Thus, the commercial embodiment of the Hi-Stress® nut includes a central projecting rectangular pilot portion having parallel re-entrant grooves, but not transverse rectangular grooves, as shown in FIG. 3 and installed as shown in FIG. 4 of the above-referenced U.S. Pat. No. 3,648,747.

Although the Hi-Stress® self-attaching nut is commercially successful because of its excellent push-off strength and relatively low cost to manufacture by the continuous rolling process described above, there are certain applications for a self-attaching nut of this type which requires sealing of the nut on the panel. Although there are several applications which require sealing of the nut on the panel, one example is the nuts which attach various elements and hardware to the inner panels or skin of the vehicle door openings, such as door latches and brackets used to attach various elements inside the door openings. Thus, one object of this invention is to provide a self-attaching nut which forms a sealed nut and panel assembly. Another object of this invention is to provide a self-attaching nut which may be continuously rolled and forming a sealed nut and panel assembly having flange bearing faces surrounding the pilot portion. Other objects of this intersect the re-entrant grooves 50 and extend through the side faces of the nut as shown in FIG. 1. In U.S. Pat. No. 3,648,747, the rectangular grooves 50 shown in FIGS. 5 and 6 intersect the re-entrant grooves 42 shown in FIGS. 3 and 4, but do not extend to the side and end faces of the nut as shown in FIG. 1a. Neither embodiment was commercially successful because the transverse rectangular grooves did not materially improve the push-off strength of the nut and panel assembly, the disclosed transverse rectangular grooves were difficult to roll in a continuous rolling process and thus added costs without a material benefit. Thus, the commercial embodiment of the Hi-Stress® nut includes a central projecting rectangular pilot portion having parallel re-entrant grooves, but not transverse rectangular grooves, as shown in FIG. 3 and installed as shown in FIG. 4 of the above-referenced U.S. Pat. No. 3,648,747.

Although the Hi-Stress® self-attaching nut is commercially successful because of its excellent push-off strength and relatively low cost to manufacture by the continuous rolling process described above, there are certain applications for a self-attaching nut of this type which requires sealing of the nut on the panel. Although there are several applications which require sealing of the nut on the panel, one example is the nuts which attach various elements and hardware to the inner panels or skin of the vehicle door openings, such as door latches and brackets used to attach various elements inside the door openings. Thus, one object of this invention is to provide a self-attaching nut which forms a sealed nut and panel assembly. Another object of this invention is to provide a self-attaching nut which may be continuously rolled and forming a sealed nut and panel assembly having flange bearing faces surrounding the pilot portion. Other objects of this invention will be understood from the following summary of the invention and the description of the preferred embodiments.

### SUMMARY OF THE INVENTION

The self-attaching nut of this invention includes a central pilot portion including a generally rectangular top pilot face, parallel side faces on opposed sides of the top face and parallel end faces on opposed ends of the top face. As will be understood, the terms “sides” or “side faces” and “ends” or “end faces” are arbitrary terms used for descriptive purposes. For the purposes of this description, the sides or side faces are the sides or side faces of the rolled nut section prior to cutting the rolled section to length and the ends or end faces are the ends or end faces of the nuts cut from the rolled nut section perpendicular to the direction of rolling. The self-attaching nut of this invention further includes a flange portion surrounding the top pilot face including a first pair of parallel top flange faces or bearing faces adjacent the parallel side faces of the pilot portion, preferably parallel to the top face of the pilot portion, and a second pair of parallel top flange faces or bearing faces adjacent the parallel end faces of the pilot portion, also preferably parallel to the top face of the pilot portion. Again, the terms “top” and “top face” or “top faces” are also arbitrary terms for purposes of description. In fact, in a typical installation of the self-attaching nut of this invention, the top pilot face and the top flange faces are oriented downwardly in a nut installation head and a plunger drives the self-attaching fastener into a panel supported on a die member in the lower die platen.

The self-attaching nut of this invention further includes a first pair of parallel grooves in the first pair of parallel top flange faces adjacent the parallel side faces of the pilot portion, preferably extending through the second pair of parallel top flange faces or through the end faces of the self-attaching nut. The preferred embodiment of the self-attaching nut of this invention further includes a second pair of parallel grooves in the second pair of parallel top flange faces adjacent the end faces of the pilot portion extending generally perpendicular to the first pair of parallel grooves, but ending in the first pair of parallel grooves and do not extend through the side faces of the self-attaching nut or the first pair of parallel top flange faces and do not extend across a width of the self-attaching nut. In the disclosed embodiment, the self-attaching nut includes a threaded bore through the pilot portion through the top pilot face. However, as set forth above, the nut bore may be unthreaded to receive a thread forming or thread rolling male fastener.

In one preferred embodiment of the self-attaching nut of this invention, the first pair of parallel grooves are re-entrant grooves, including inner side walls defined by the parallel side faces of the pilot portion inclined outwardly from a bottom wall and outer side walls adjacent the first pair of parallel top flange faces inclined inwardly toward the parallel side faces of the pilot portion. In one preferred embodiment, the bottom wall of the first pair of parallel grooves is V-shaped. The configuration of the second pair of parallel grooves will depend upon the application. In one disclosed embodiment, the second pair of parallel grooves includes outer side walls inclined outwardly from a bottom wall to the second pair of parallel flange faces. In a second preferred embodiment, the second pair of parallel grooves includes an outer wall inclined inwardly from the second pair of parallel flange faces to a bottom wall of the grooves, overlying the bottom wall, improving the push-off strength of the nut and panel assembly. In a third preferred embodiment, the second pair of parallel grooves include inner side walls defined by the parallel end faces of the pilot portion inclined inwardly from adjacent the top pilot face to a bottom wall overlying the bottom wall, thereby improving the push-off strength of the nut and panel assembly. Alternatively, the second pair of parallel grooves may be re-entrant grooves, wherein the inner and outer side walls are inclined toward each other.

Further, in a preferred embodiment of the self-attaching nut of this invention, the four corners of the pilot portion at the intersection between the side faces and the end faces are rounded to reduce or eliminate stress risers formed in the panel during installation or cracking of the panel at the corners of the pilot portion improving the seal between the self-attaching nut and the panel following installation. As used herein, the term “panel” includes any plate, sheet or panel, particularly, but not exclusively including a metal panel, such as steel or aluminum, as generally used by the automotive industry for body panels, brackets or the like, but also includes a plastic panel.

The sealed self-attaching nut and panel assembly of this invention thus includes a self-attaching nut, as described above, and a panel including a generally rectangular opening configured to receive and receiving the top face of the pilot portion therethrough, first parallel panel portions deformed into the first pair of parallel grooves, preferably extending across the length of the self-attaching nut, and second panel portions deformed into the second pair of parallel grooves between the first pair of parallel grooves, but not extending across the width of the self-attaching fastener and providing a sealed nut and panel assembly. The self-attaching nut of this invention may also be formed in a continuous rolling process as described further below.

As will be understood by those skilled in this art, the following description of the preferred embodiments of the self-attaching nut and sealed nut and panel assembly are for illustrative purposes only and do not limit this invention except as set forth in the appended claims. Various modifications may be made to the self-attaching nut and sealed nut and panel assembly of this invention as described further hereinbelow.

### BRIEF DESCRIPTION OF THE DRAWINGS

FIG. 1 is a top perspective view of one embodiment of a self-attaching nut of this invention;

FIG. 1A is a partial enlarged view of FIG. 1 with a portion of the side flange portion broken away to illustrate an intersection of the grooves;

FIG. 2 is a top view of the embodiment of the self-attaching nut shown in FIG. 1;

FIG. 3 is an end cross-sectional view of the self-attaching nut shown in FIGS. 1 and 3 in the direction of view arrows 3-3 in FIG. 2, including frangible wires and a panel illustrated in phantom;

FIG. 4 is a side cross-sectional view of the self-attaching nut shown in FIGS. 1 and 2 in the direction of view arrows 4-4 in FIG. 2 including a panel shown in phantom;

FIG. 5 is a partial cross-sectional view of FIG. 3 illustrating a method of installing the self-attaching nut of FIGS. 1 and 2 in a panel;

FIG. 6 is a partial cross-sectional view of FIG. 4 illustrating a method of installing the self-attaching nut of FIGS. 1 and 2 in a panel;

FIG. 7 is a top view of the self-attaching nut shown in FIGS. 1 and 2 installed in a panel;

FIG. 8 is a side cross-sectional view similar to FIG. 4 of an alternative embodiment of the self-attaching nut of this invention; and

FIG. 9 is a side cross-sectional view similar to FIG. 4 of a third alternative embodiment of the self-attaching nut of this invention.

### DESCRIPTION OF THE PREFERRED EMBODIMENTS

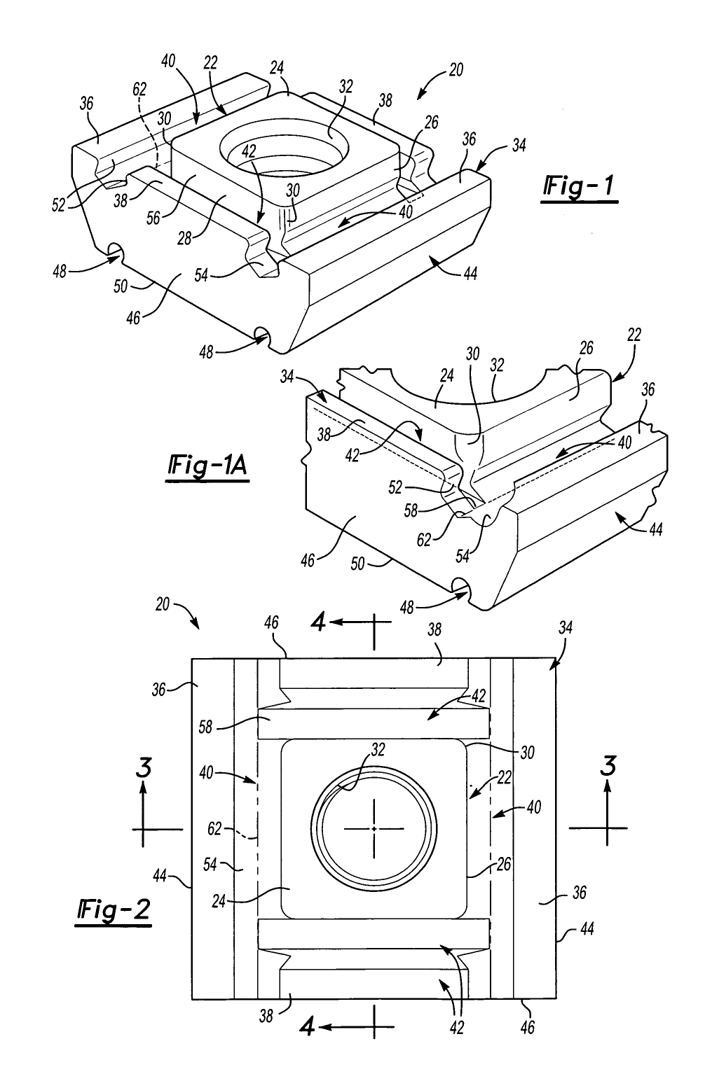

The embodiment of the self-attaching nut 20 shown in FIGS. 1 and 2 includes a central pilot portion 22 having a generally rectangular planar top face 24. As set forth above, the self-attaching nut 20 may be utilized as either a pierce nut or a clinch nut. The generally rectangular pilot portion 22 includes parallel side faces 26 and parallel end faces 28 and, in one preferred embodiment of the self-attaching nut 20 of this invention, the corners 30 of the pilot portion 22 are round or arcuate to reduce stress fractures in the panel during installation and thus provide an improved seal of the nut forming a sealed nut and panel assembly described below. Further, the rounded corners 30 of the pilot portion 22 prevent rolling down of the corners during piercing and installation of the nut 20 in a panel which may prevent release of the panel slug through the die button. The self-attaching nut 20 includes a central bore 32 extending through the top face 24. The bore 32 may be threaded as shown or the bore may be cylindrical to receive a thread forming or thread rolling male fastener, such as a bolt.

In the preferred embodiments of the self-attaching nut of this invention, the nut 20 includes an integral flange portion 34 surrounding the pilot portion 22 including a first pair of parallel top flange faces 36 adjacent the parallel side faces 26 of the pilot portion 22, preferably extending across the length of the self-attaching nut fastener and a second pair of parallel top flange faces 38 adjacent the parallel end faces 28 of the pilot portion 22 forming panel bearing surfaces generally surrounding the pilot portion 22. The first pair of parallel top flange faces 36 include a first pair of parallel grooves 40 adjacent the parallel side faces 26 of the pilot portion 22 and the second pair of parallel top flange faces 38 each include a second pair of parallel grooves 42 adjacent the parallel end faces 28 of the pilot portion 22. In a preferred embodiment, the second pair of parallel grooves 42 are perpendicular to the first pair of parallel grooves 40. In the disclosed embodiment, the self-attaching nut 20 includes parallel side faces 44 and planar end faces 46. In the disclosed embodiment, the self-attaching nut further includes parallel wire grooves 48 in the planar bottom face 50 of the nut extending through the parallel end faces 46 of the nut 20. In one preferred embodiment, the generally rectangular top face 24 of the pilot portion 22 is spaced above the planes of the top flange faces 36 and 38 as shown in FIG. 1 to facilitate piercing of a panel by the pilot portion 22. However, although not preferred, the top flange faces 36 and 38 may also be in the same plane as the top face 24 of the pilot portion 22 or below. However, in a preferred embodiment the second top flange faces 38 are coplanar with the first top flange faces 36.

One advantage of the disclosed embodiments of the self-attaching nut of this invention is that the nut can be rolled from a continuous generally cylindrical wire in a rolling mill having a cross-section in the form of the end faces 46. That is, the rolled nut section will include the first pair of parallel grooves 40 which extend through the end faces 46 described further below. During the rolling process, the transverse second pair of parallel grooves 42 may be rolled by transverse rollers (not shown). The nut section is then cut to length or blanked, forming the parallel planar end faces 46 of the nut. The central bore 32 may be pierced from the nut section following rolling and tapped, if required. Thus, the faces 44 of the flange portion 34 and the faces 26 of the pilot portion 22 are referred to herein as the “side faces” and the faces 28 of the pilot portion and the faces 46 of the nut 20 are referred to as the “end faces.” Further, the length of the nut is referred to herein as the distance between the end faces 46 and the width of the nut is referred to herein as the distance between the side faces 44 for ease of description and based upon the rolling process.

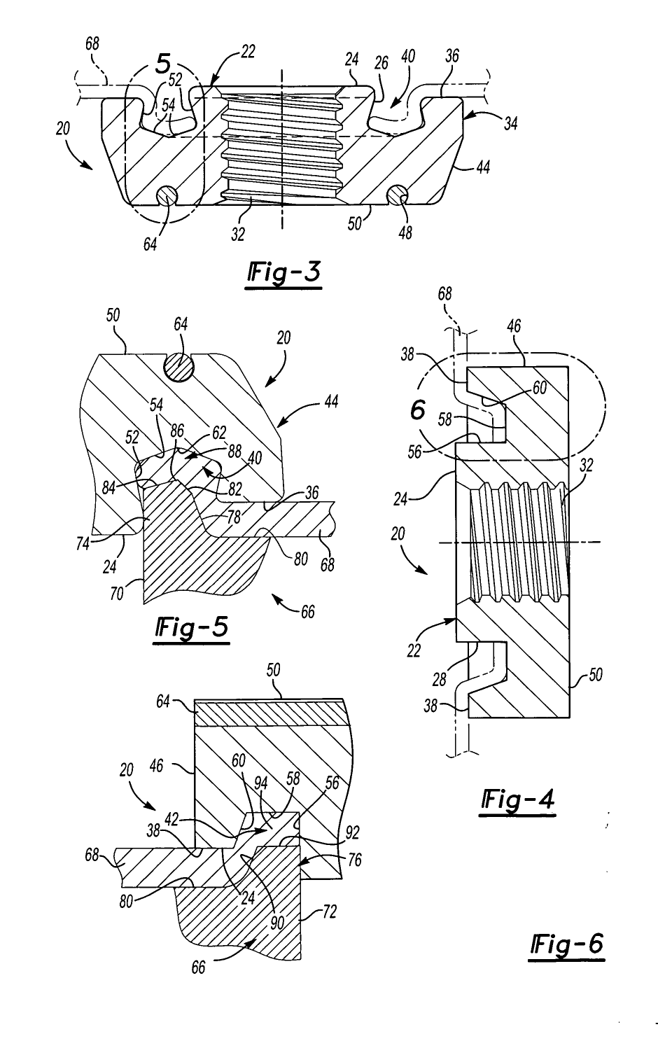

In a preferred embodiment of the self-attaching nut of this invention, the first pair of parallel grooves 40 are re-entrant grooves and extend through the end faces 46 of the nut 20. That is, the width of the opening of the first pair of parallel grooves 40 is less than the width of the grooves 40 at the bottom of the grooves as described further below. The re-entrant grooves 40 significantly improve the push-off strength of the self-attaching nut 20 following installation in a panel as also discussed above. In the disclosed embodiment, the opposed side faces 52 of the parallel re-entrant grooves 40 are inclined toward each other from the V-shaped bottom wall 54 as best shown in FIGS. 1 and 3. However, the bottom wall 54 may also be flat and a re-entrant groove may be formed by inclining the outer wall toward the pilot portion 22 or the inner wall toward the side faces 26 of the pilot portion 22.

In the embodiment of the self-attaching nut 20 shown in FIGS. 1 to 4, the transverse second pair of parallel grooves 42 each include an inner side wall 56 which extends perpendicular to the top face 24 of the pilot portion 22, a bottom wall 58 which extends perpendicular to the inner side wall 56 and parallel to the top face 24 of the pilot portion 22 and an outer side wall 60 which is inclined outwardly relative to the inner side wall 56 from the bottom wall 58 as best shown in FIG. 4. However, as described below with regard to FIGS. 8 and 9, the second pair of parallel grooves 42 may also be re-entrant, wherein the side walls 156 and 160 may be inclined toward each other or one of the side walls may be inclined toward the other side wall. As best shown in FIGS. 3 and 4, the inner side face of the first pair of parallel grooves 40 are also the side faces of the pilot portion 22 and the inner side faces 56 of the second pair of parallel grooves 42 are also the end faces 28 of the pilot portion 22. In a preferred embodiment of the self-attaching nut of this invention, the second pair of parallel grooves 42 do not extend through the first pair of parallel top flange faces 36 as shown in FIG. 1. That is, the grooves 42 are spaced from the flange portions adjacent the side faces 26 of the pilot portion 22. In one preferred embodiment, the bottom wall 58 of the second pair of parallel grooves 42 are at the same plane as the bottom wall 54 of the first pair of parallel grooves 40. As best shown in FIG. 1A, the bottom wall 58 of the second pair of parallel grooves 52 intersect the apex 62 of the V-shaped bottom wall 54 such that panel metal deformed into the transverse grooves 40 and 42 blend together, avoids rupture at the corners and provides a sealed joint.

As described in the above-referenced U.S. Pat. No. 3,845,860, self-attaching nuts of this type may be interconnected by frangible wires 64 shown in FIG. 3 which are received in the parallel wire grooves 48 and retained in place by any suitable means, including knurling, thereby forming a continuous strip of interconnected self-attaching fasteners. The strip of fasteners are then fed to an installation head (not shown), described in the above-referenced U.S. Pat. No. 3,845,860. The installation head may, for example, be attached to the upper die shoe of a press and the lower die shoe includes a die member or die button 66 shown in part in FIGS. 5 and 6 and described further below. In a typical application, the installation head (not shown) includes a reciprocating plunger which, upon closing of the press, drives the self-attaching nut 20 against a panel 68 supported on the die button 66 as now described. Where the self-attaching nut 20 is utilized as a pierce nut, the panel is pierced by the top face 24 of the pilot portion 22 in conjunction with the projecting lips of the die button as described below. However, where the self-attaching nut is utilized as a clinch nut, a panel opening may first be formed in the panel 68.

In the disclosed embodiment of the die button 66, the die button has a central generally rectangular opening formed by the parallel side faces 70 and the transverse parallel end faces 72. The generally rectangular opening is surrounded by projecting lips, including parallel side lips 74 which are received in the first pair of parallel grooves 40 and parallel end lips 76 which are received in the second pair of parallel grooves 42. Because the first pair of parallel grooves 40 in a preferred embodiment are perpendicular to the second pair of parallel grooves 42 as shown in FIGS. 1 and 2, the second pair of parallel projecting lips 76 are also perpendicular to the first pair of projecting parallel lips 74, forming a generally rectangular opening as described above. Where the self-attaching nut is utilized as a pierce nut, the panel is pierced between the outer surfaces of the pilot portion 22 and the inner surfaces 70 and 72 of the die button forming a panel slug (not shown) which is received through the rectangular opening. In the disclosed embodiment of the die button 66, the first parallel projecting lips 74 include first inwardly inclined faces 78 which are inclined inwardly from the end face 80 of the die button 66, a second inwardly inclined face 82 which is inclined at a steeper angle relative to vertical (side face 70) and an outwardly inclined end face 84 which intersects the second inwardly inclined face 82 at an apex 86 generally aligned with the apex 62 of the V-shaped bottom wall 54 of the re-entrant grooves 40 as shown in FIG. 5. Further, as shown in FIG. 5, the parallel side lips 74 drive panel metal 88 into the re-entrant grooves 40 and against the V-shaped bottom wall 54, beneath the relatively inclined side walls 52, securely retaining the panel metal 88 in the re-entrant grooves 40. The parallel side lips are sometimes referred to as the “piercing lips.”

The parallel end lips 76 in this embodiment include inwardly inclined faces 90 and an end face 92 which is parallel to the bottom wall 60 of the second pair of parallel grooves 42 as shown in FIG. 6. Panel metal 94 is thus driven into the second pair of parallel grooves 42 and against the bottom wall 58 as shown in FIG. 6. The parallel end lips 76 are sometimes referred to as the “clinching lips.”

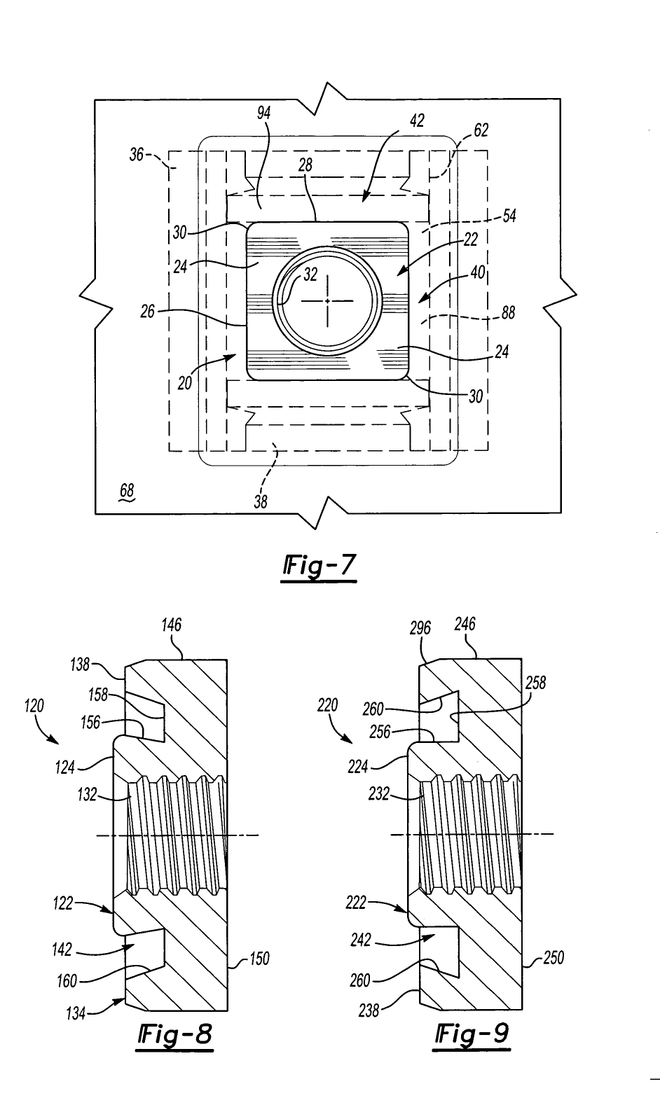

FIG. 7 illustrates a sealed nut and panel assembly formed by the self-attaching nut 20 by the method of installation described above with regard to FIGS. 5 and 6. As shown in FIG. 7, the generally rectangular end face 24 of the pilot portion 22 projects through the panel 68, panel portions 88 are deformed into the first pair of parallel grooves 40 on opposed side faces 26 of the pilot portion 22 and second panel portions 94 are deformed into the second pair of parallel grooves 42 which extend perpendicular to the first pair of parallel grooves 40. The panel metal 88 deformed into the first pair of parallel grooves 40 extends across the length of the self-attaching nut 20. However, the panel metal 94 deformed into the second pair of parallel grooves 42 extends only to adjacent the apex 62 of the V-shaped bottom wall 54. As described above, the rounded corners 30 of the pilot portion 22 prevents stress risers or stress cracks in the panel 68 which may result in leakage through the panel 68 and permit release of the panel slug. Further, as shown in FIGS. 5 and 6, the panel 68 is fully supported on the first parallel top flange faces 36 and the transverse second pair of parallel top flange faces 38, forming a sealed joint between the panel 68 and the self-attaching nut 20 which is an object of this invention.

FIGS. 8 and 9 illustrate two alternative embodiments of the self-attaching nut of this invention, wherein the second pair of parallel grooves are re-entrant grooves as discussed above. In the embodiment of the self-attaching nut 120 shown in FIG. 8, the inner side walls 156 of the second pair of parallel grooves 142 are inclined outwardly toward the second pair of parallel top flange faces 38 of the flange portion 134, forming re-entrant grooves. The self-attaching fastener 120 may otherwise be identical to the self-attaching fastener 20 described above and the elements of the self-attaching nut 120 are numbered the same as the elements of the self-attaching fastener 20, except in the 100 series. Re-entrant grooves 142 provide superior push-off strength when installed in a panel as described above because the inner side walls 156 overly the bottom wall 158.

The third embodiment of the self-attaching nut 220 shown in FIG. 9 also includes parallel re-entrant grooves 242, which are the second pair of parallel grooves described above. In this embodiment, the outer side walls 260 of the second pair of parallel grooves 242 are inclined inwardly from the bottom wall 258 toward the pilot portion 222 forming a restricted opening and significantly improving the push-off strength of the fastener 220 when installed in a panel. Again, the elements of the self-attaching nut 220 may be otherwise identical to the self-attaching nut 20 described above except for the re-entrant groove 242 and the elements of the self-attaching nut 220 are the same as the self-attaching nut 20, except in the 200 series. In this embodiment, however, the upper portion 296 of the end faces 246 may be inclined inwardly during the rolling process to form the inclined outer wall 260. Alternatively, both the inner and outer side walls of the second pair of parallel grooves may be inclined toward each other. That is, the inner wall may be inclined outwardly as shown at 156 in FIG. 8 and the outer wall may be inclined inwardly as shown at 260 in FIG. 9.

As will now be understood, the self-attaching nut and sealed nut and panel assembly of this invention provides important advantages over the prior art. First, the self-attaching nut of this invention forms a sealed nut and panel assembly as described above. This is a result of the groove configuration of the self-attaching nut, wherein the first pair of parallel grooves 40 extend across the length of the self-attaching nut and are preferably re-entrant grooves, providing excellent push-off strength, and the second pair of parallel grooves (42, 142, 242) which are perpendicular to the first pair of parallel grooves, intersect the first pair of grooves 40, but do not extend through the second pair of parallel top flange faces 36 which support the panel following installation. In a preferred embodiment, the bottom walls (58, 158, 258) are in the same plane as the bottom walls 58 of the first pair of parallel grooves 40. In the disclosed embodiment, wherein the bottom walls 54 of the first pair of parallel grooves 40 are V-shaped, the bottom wall (58, 158, 258) intersects the apex 62 of the V-shaped bottom wall 54. Further, the panel 68 is fully supported completely around the pilot portion (22, 122, 222) by the first pair of parallel top flange faces 36 and the second pair of parallel top flanges (38, 138, 238) in sealed relation. Further, the rounded corners 30 of the pilot portion prevent stress risers in the panel during installation of the self-attaching nut in the panel which may result in cracking of the panel and leakage through the panel and roll down of the corners of the pilot and assure release of a slug pierced from the panel. Finally, the embodiments of the self-attaching nut disclosed herein may be continuously rolled in a rolling mill as described above.

As will be understood by those skilled in this art, various modifications may be made to the self-attaching nut and nut and panel assembly of this invention within the purview of the appended claims. For example, the first pair of parallel re-entrant grooves 40 may have a planar bottom wall, rather than the V-shaped bottom wall 54 disclosed in FIGS. 1 to 3 and 5. Further, as described above, the inner and outer walls of the second pair of parallel grooves (42, 142, 242) may be inclined toward each other providing further improved push-off strength. Further, the self-attaching nuts of this invention may be fed to an installation head in bulk form, eliminating the requirement for frangible wires 64. The self-attaching nut of this invention is preferably formed of steel by rolling as described above, particularly where the self-attaching nut is utilized as a pierce nut for installation in a metal panel, wherein the pierce nut is preferably formed of a steel which is harder than the panel. However, the self-attaching nut may also be installed in other metal panels including aluminum and plastic panels. In most applications, the thickness of the panel 68 is preferably about equal to the distance between the first and second pair of parallel top flange faces and the end face of the pilot portion to form a flush installation. However, as set forth above, the first and second pair of parallel top flange faces may also be co-planar with the end face of the pilot portion, although generally not preferred. Having described the preferred embodiments of the self-attaching nut and sealed nut and panel assembly of this invention, the invention is now claimed as follows.

1. A self-attaching nut, comprising:
a central pilot portion including a generally rectangular top pilot face, parallel side faces on opposed sides of said top face, and parallel end faces on opposed ends of said top face;
a bore through said pilot portion through said top pilot face;
a flange portion surrounding said top pilot face of said pilot portion, including a first pair of parallel top flange faces adjacent said parallel side faces of said pilot portion parallel to said top pilot face, and a second pair of parallel top flange faces adjacent said parallel end faces parallel to said top face of said pilot portion;
a pair of parallel grooves in said first pair of parallel top flange faces adjacent said parallel side faces of said pilot portion extending through said second pair of parallel top flange faces; and
a second pair of parallel grooves in said second pair of parallel top flange faces adjacent said parallel end faces of said pilot portion generally perpendicular to said first pair of parallel grooves ending in said first pair of parallel grooves such that said first pair of parallel top flange faces extend across a length of said self-attaching nut.

2. The self-attaching nut as defined in claim 1, wherein said first pair of parallel grooves include inner side walls defined by said parallel side faces of said pilot portion inclined outwardly from a bottom wall to overly said bottom wall and an outer wall adjacent said first pair of parallel flange faces inclined inwardly toward said parallel side faces of said pilot portion to overly said bottom wall, such that said first pair of parallel grooves has a restricted opening.

3. The self-attaching nut as defined in claim 2, wherein said bottom wall of said first pair of parallel grooves is V-shaped.

4. The self-attaching nut as defined in claim 1, wherein said second pair of parallel grooves include outer walls inclined outwardly from a bottom wall to said second pair of parallel flange faces.

5. The self-attaching nut as defined in claim 1, wherein said second pair of parallel grooves include outer walls inclined inwardly from said second pair of parallel flange faces to a bottom wall overlying said bottom wall.

6. The self-attaching nut as defined in claim 1, wherein said second pair of parallel grooves include inner walls defined by said parallel end faces of said pilot portion inclined inwardly from adjacent said top pilot face to a bottom wall overlying said bottom wall.

7. The self-attaching nut as defined in claim 1, wherein corners of said generally rectangular top pilot face are rounded.

8. A self-attaching sealed nut and panel assembly:
a self-attaching nut including a central pilot portion having a generally rectangular top pilot face, parallel pilot side faces on opposed sides of said top face, and parallel pilot end faces on opposed ends of said pilot top face, a bore through said pilot portion through said top face, a flange portion surrounding said top pilot face, including a first pair of parallel planar bearing faces adjacent said parallel pilot portion side faces and a second pair of parallel planar bearing faces adjacent said parallel pilot end faces, a first pair of parallel grooves in said first pair of planar bearing faces adjacent said parallel pilot side faces and a second pair of parallel grooves in said second pair of planar bearing faces ending in said first pair of parallel grooves, such that said first pair of planar bearing faces extend across a length of said self-attaching nut; and
a metal panel having a generally rectangular opening receiving said top pilot face therethrough, first panel portions received on said first pair of planar bearing faces and deformed into said first pair of parallel grooves and second panel portions received on said second pair of planar bearing faces and deformed into said second pair of parallel grooves, such that said panel is attached to said self-attaching nut in sealed relation.

9. The sealed self-attaching nut and metal panel assembly as defined in claim 8, wherein said second pair of parallel grooves includes side walls overlying a bottom wall, and said second panel portion is deformed into said second pair of parallel grooves beneath said side walls.

10. The sealed self-attaching nut and metal panel assembly as defined in claim 9, wherein said second pair of parallel grooves include inner side walls adjacent said parallel pilot end faces overlying said bottom wall and said second panel portion is deformed into said second pair of parallel grooves beneath said inner side walls.

11. The sealed self-attaching nut and metal panel assembly as defined in claim 9, wherein said second pair of parallel grooves includes outer side walls inclined inwardly from said second pair of planar bearing faces overlying said bottom wall and said second panel portion is deformed into said second pair of parallel grooves beneath said outer side walls.

12. The sealed self-attaching nut and panel assembly as defined in claim 9, wherein the intersections of said pilot side faces and said pilot end faces are rounded and said generally rectangular opening in said panel includes rounded corners.
